(19) United States
(12) Patent Application Publication
(10) Pub. No.: US 2005/0194044 A1
(43) Pub. Date: Sep. 8, 2005

(54) Hydrodynamics control method and apparatus

(76) Inventor: Jerry M. Edmondson, Newport Beach, CA (US)

Correspondence Address: JERRY M. EDMONDSON, 2 ESCAPADE CT., NEWPORT BEACH, CA, 92663, US

(21) Appl. No.: 10/792,197

(22) Filed: Mar. 3, 2004

(51) Int. Cl. B01D 17/028

(52) U.S. Cl. 137/172

(57) ABSTRACT

A method and apparatus for establishing a plug flow of fluid through a process vessel utilizing a permeable barrier placed in the flow path of the fluid being processed within the vessel causing the fluid to spread out over the surface of the leading edge of the permeable barrier and can include a means for adjusting the permeability of the barrier in discrete areas of the barrier to compensate for variations in feed rate, density and viscosity of the fluid being processed and further the permeable barrier may be of a louvered shutter type construction with the louvers being adjustable from wide open to closed and if desired can include a mechanism on the exterior of the vessel for adjusting the internal louvers.

### FIELD OF THE INVENTION

This invention relates to a method and apparatus for assuring that fluid passing through a process vessel, in which the occurring process is time sensitive, travels through the vessel as a continuous mass thereby maximizing residence time. Such a flow pattern is termed plug flow.

### BACKGROUND OF THE INVENTION

It is a well-known fact that flowing fluids will follow the path of least resistance and therefore in processing vessels, considering more friction at the vessel wall and less friction at vapor/liquid and liquid/liquid interfaces, some of the fluid will normally pass through the vessel in less time than other of the fluid. Further the vessel may be processing a composite fluid of various densities and viscosities wherein the various components of the composite fluid may travel through the vessel in different areas of the vessel and therefore the resistance to flow will be different in various locations within the vessel. As many processes occurring inside of processing vessels are time sensitive, such as the separation of water from oil, it is desirable to maintain a constant rate of flow for all of the fluids passing through the vessel. The term “plug flow” is generally used to describe that all of the fluids are flowing at a fixed rate of flow as a continuous mass.

This invention introduces a method and apparatus for altering the path of least resistance to fluid flow inside of a process vessel and doing so in a way whereby the path of least resistance to flow can be varied in different areas of the vessel to facilitate a “plug flow” throughout the vessel.

### SUMMARY OF THE INVENTION

This invention is well suited for application inside of a process vessel wherein the process taking place in the vessel is time sensitive such as with the separation of water from oil and the normal flow rate will be affected by wall friction slowing the flow rate of fluids next to the vessel wall while fluids next to liquid/vapor and liquid/liquid interfaces are subjected to less friction and will flow faster to the degree that some of the fluid may not have sufficient residence time to attain the desired process result.

This invention provides a means for compensating for more and less resistance to normal flow in different areas of the fluid flow path by incorporating a permeable barrier of variable permeability transversing the fluid flow path thereby imposing a variable pressure drop by obstructing the fluid flow path and causing the fluids to spread out across the surface of the permeable barrier thus creating a plug flow throughout the flow path.

The permeable barrier may have more or less permeability at various locations on the barrier to compensate for varying fluid feed rates, densities and viscosities and can be of a louvered shutter construction whereby the open area of the shutter may be adjusted by opening or closing the louvers.

### BRIEF DESCRIPTION OF THE DRAWINGS

FIG. 1. is a side view schematic showing all of the essential elements of the preferred embodiment of this invention as applied to a processing vessel of horizontal orientation and includes a cross sectional view.

FIG. 2. is a side view schematic showing all of the essential elements of the preferred embodiment of this invention as applied to a processing vessel of vertical orientation and includes a cross sectional view.

### DETAILED DESCRIPTION OF THE PREFERRED EMBODIMENT

(Referring to the Figures)

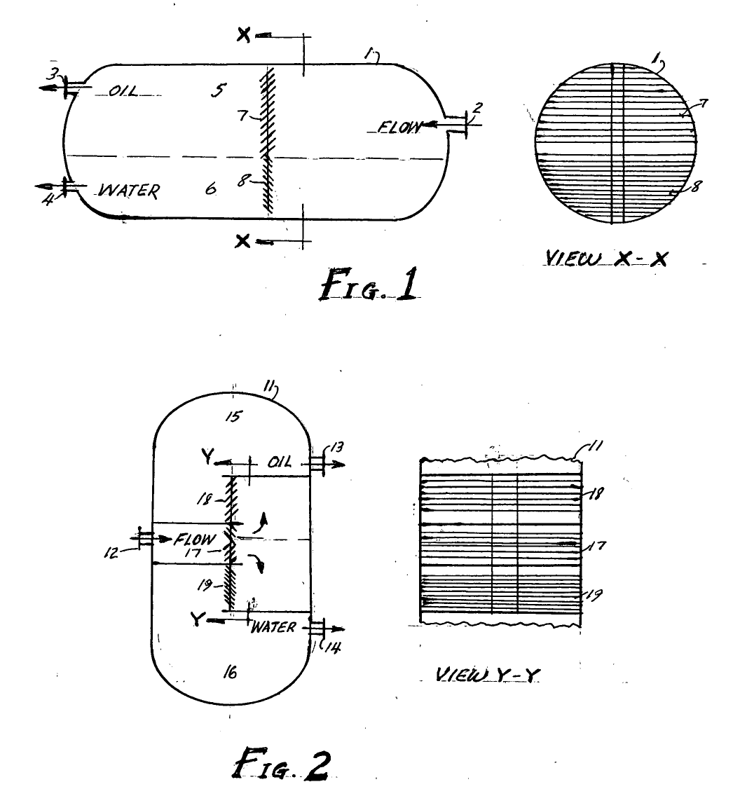

FIG. 1 shows a horizontal cylindrical enclosed vessel 1 with an inlet conduit 2 on one end, oil outlet conduit 3 and water outlet conduit 4 on the opposite end. In this configuration considering a mixture of oil and water entering the vessel through the inlet conduit 2, oil will pass through an upper portion 5 of the vessel and water through a lower portion 6 of the vessel. There is a permeable barrier 7 located in the flow path of the oil and an additional permeable barrier 8 in the flow path of the water. The permeable barriers will establish a plug flow of both the oil and the water.

FIG. 2 shows a vertical cylindrical enclosed vessel 11 with an inlet conduit 12 near the middle of the vessel, oil outlet conduit 13 in the upper portion of the vessel and water outlet conduit 14 in the lower portion of the vessel. In this configuration considering a mixture of oil and water entering the vessel through the inlet conduit 12, oil will flow to an upper portion 15 of the vessel and water to a lower portion 16 of the vessel. There is a permeable barrier 17 located in the flow path of the inlet stream, a permeable barrier 18 located in the flow path of the oil and a permeable barrier 19 located in the path of the water. The permeable barriers will establish a plug flow of both the oil and the water.

The permeable barriers can be of a louvered shutter construction whereby the louvers can be opened or closed to compensate for variations in fluid flow rate, density and viscosity. If desired a mechanism can be provided on the vessel exterior connected to the internal louvers to open and close the louvers.

1. A method for establishing a plug flow through a process vessel comprising an enclosed cylindrical container, an inlet conduit, an outlet conduit and a permeable barrier placed in the flow path of fluid that is passing through said container, said permeable barrier constructed in a manner that will permit adjustment of the permeability to compensate for variations in the feed rate, density and viscosity of the said fluid.

2. The method of claim 1 whereby said permeable barrier is of louvered shutter construction with the louvers being adjustable from wide open to closed.

3. The method of claim 1 whereby the permeability of said permeable barrier can be discretely regulated at various areas on said barrier.

4. The method of claim 2 and including a mechanism on the exterior of said vessel connected to said permeable barrier in a manner that will permit manipulation of the louvers.

5. An apparatus for establishing a plug flow of fluid passing through a process vessel consisting of a permeable barrier placed within said vessel in the flow path of said fluid and including a means for adjusting the permeability of the said barrier.

6. An apparatus of claim 5 including a louvered shutter type construction of the permeable barrier with a means for discrete adjustment of the permeability of various areas of said barrier.

7. An apparatus of claim 6 including an external means on said vessel connected to said louvered shutter type permeable barrier in such a manner as to permit discrete adjustment of the louvers from wide open to closed.
